(19) United States
(12) Patent Application Publication
(10) Pub. No.: US 2008/0101258 A1
(43) Pub. Date: May 1, 2008

(54) METHOD FOR CONFIGURING NETWORK CONNECTIONS UTILIZING A GRAPHICAL USER INTERFACE SHOWING NETWORK TOPOLOGY

(76) Inventor: Eric Cheng, Taipei (TW)

Correspondence Address: SINORICA, LLC, 528 FALLSGROVE DRIVE, ROCKVILLE, MD, 20850, US

(21) Appl. No.: 11/555,540

(22) Filed: Nov. 1, 2006

(51) Int. Cl. H04L 12/28

(52) U.S. Cl. 370/254

(57) ABSTRACT

A method for easily configuring a network, network connections, and electronic devices in the network is disclosed. A user interface conveniently displays the current network configuration in a topological diagram. Each device in the network is displayed as an icon. Connections between the devices are also shown in the user interface. If a user decides to reconfigure the network, the user simply clicks on the appropriate icon and drags the device to the desired location. The new connection is automatically established and the topological diagram of the network in the user interface is automatically updated to display the new network configuration. If the new configuration is not compatible, the user interface displays a warning message explaining the conflict to the user. The user interface also comprises a relation list showing connection relationship between devices, a connection status area showing connection status, and an unused device area.

### BACKGROUND OF THE INVENTION

1. Field of the Invention

The present invention relates to networks and network connections. More specifically, the present invention discloses a method for easily connecting and configuring network connections and electronic devices utilizing a graphical user interface displaying a topological diagram of available network connections and devices.

2. Description of the Prior Art

The conventional method for configuring a network and devices in the network is overly complex and not user friendly. It requires users to possess technical knowledge or experience in order to configure or reconfigure the network and the network devices. This prevents typical users from completing the configuration.

The conventional method requires a user to complete multiple set up forms provided by the operating system in order to configure each device and each device's connection configuration. Not only is this traditional method time consuming, but it is also too complex for a typical user.

For example, in order to install a conventional access point a user must perform a number of steps in order to complete the set up. Some of the required steps are to set the 802.11 settings such as transmit power, encryption, authentication, request-to-send/clear-to-send, and fragmentation. If any of these settings are incorrect, the access point will be unable to communicate with the computer.

In addition to these settings, the user must manually configure the Internet Protocol (IP) address. In order to configure the IP address the user must physically connect the computer to the access point via a serial cable. This is time consuming and inconvenient for the user. In order to configure the access point, the user must use a configuration program running on the computer while the computer is physically connected to the access point. The user must also configure the access point to a specific role such as access point, client access point, repeater, etc. The detailed steps required to complete the installation are often too complex for most users. As a result, the installation usually needs to be performed by a professional technical consultant which can be expensive.

While an AP improves the convenience of wirelessly connecting to the Internet, conventional APs are inconvenient to set up. Additionally, it is very difficult for a typical user to troubleshoot communication problems. If the user's computer is unable to establish a connection with the AP, the user is unable to identify the problem. They only know that the network connection failed. Furthermore, if a user needs to reconfigure the configuration of their network the computer must be physically reconnected to the access point and the above installation routine must be performed again.

As a result, users are easily frustrated when trying to set up or manage their wireless network. Furthermore, since these problems are common in conventional wireless network systems, users have been slow to adopt APs.

Therefore, there is need for an improved method for easily connecting and configuring network connections and electronic devices that conveniently displays the current network configuration in a topological graphical user interface and allows users to easily re-configure the network by dragging icons of the devices to new locations in the topological diagram of the user interface.

### SUMMARY OF THE INVENTION

To achieve these and other advantages and in order to overcome the disadvantages of the conventional method in accordance with the purpose of the invention as embodied and broadly described herein, the present invention provides a method for easily configuring a network, network connections, and electronic devices in the network.

The method of the present invention utilizes a user interface that conveniently displays the current network configuration in a topological diagram. Each device in the network is displayed as an icon. Connections between the devices are also shown in the user interface. If a user decides to reconfigure the network, the user simply clicks on the appropriate icon and drags the device to the desired location. The new connection is automatically established and the topological diagram of the network in the user interface is automatically updated to display the new network configuration. If the new configuration is not compatible, the user interface displays a warning message explaining the conflict to the user. In this way, users don't need to be concerned about improper configuration. As a result, users can easily configure their network without possessing a high level of technical experience.

Also included in the user interface is a relation list which displays the relationship between access points and access point clients. The relation list comprises two sections, one section for access points and one section for access point clients. The connections between the access points and access point clients are displayed graphically with icons for each device. As with the topological diagram or topological list, a user can simply drag an icon to a new location and the new connection is established. Also, a warning message will notify the user if the connection or configuration is improper.

The user interface of the present invention also comprises a display of the connection status. When a user clicks on a device, the connections and devices that are connected to the device are displayed in the connection status section of the user interface.

Any unused devices that are present but not configured as part of the network are displayed in an unused device section of the user interface. A user can utilize an unused device by simply dragging the icon of the device into either the topological list or relation list of the user interface. If the configuration is compatible, the user interface is updated to display the new network configuration.

The present invention automatically resolves network connections and allows the user to easily access the network or device connected to an access point (AP). Additionally, the topological user interface allows the user to easily configure the connections between devices and networks.

In addition to wirelessly connecting a computer to a network, the present invention can also be used in different applications such as Wi-Fi speakers, Wi-Fi TV applications, etc. For example, a computer can wirelessly connect to the Wi-Fi speakers and audio files being played on the computer will be heard from the Wi-Fi speakers. Using the method of the present invention, users can easily connect to wireless enabled devices.

In an embodiment of the present invention all application devices' default setting is AP mode. This means that when the device is powered on or reset, the device automatically configures as an access point. The computer scans and configures the settings for the device via a wireless connection. Since the device is automatically set to AP mode, the computer can easily detect the device and establish a connection.

The device can be set to AP client mode and perform applications via another AP. For example, in a network where there is already one AP and the new device is added, the new device will be detected as a second AP. The new device can then be reconfigured as an AP client connected to the original AP. Once the wireless connection is established the computer can transmit data or content to the device.

A connection database works together with the user interface. All connection information is stored in a database. The database tracks all wireless network configurations. If a previously available AP is not detected during scanning of the network the present invention will notify the user. The user can decide whether to rescan or remove the connection information.

Using the present invention users can easily reconfigure the configuration of the network and role of access points and access point clients. If any problems with the configuration of the network are encountered, users are notified and the problems can be easily resolved.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a block diagram illustrating a wireless network environment according to an embodiment of the present invention;

FIG. 1B is a diagram illustrating a graphical user interface with topological diagram of network configuration according to an embodiment of the present invention;

FIG. 2A is a diagram illustrating a basic wireless environment according to an embodiment of the present invention;

FIGS. 2B-2G are diagrams illustrating a graphical user interface for the computer of the wireless network environment of FIG. 2A according to embodiments of the present invention;

FIG. 3A is a diagram illustrating a software user interface for a computer of a wireless network environment according to an embodiment of the present invention;

FIG. 3B is a diagram illustrating a graphical user interface for a computer of a wireless network environment according to an embodiment of the present invention; and

FIG. 3C is a diagram illustrating a graphical user interface warning message.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

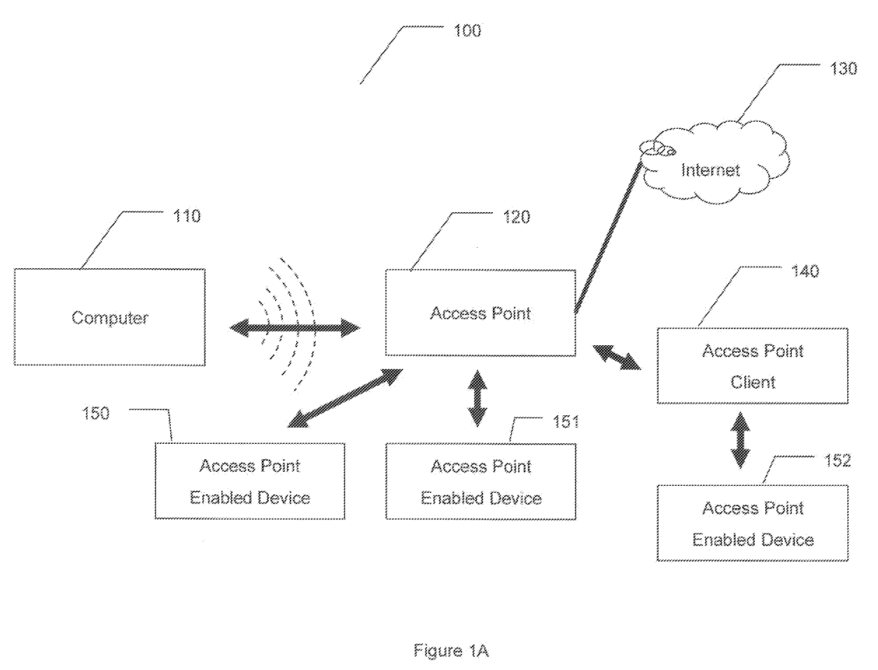

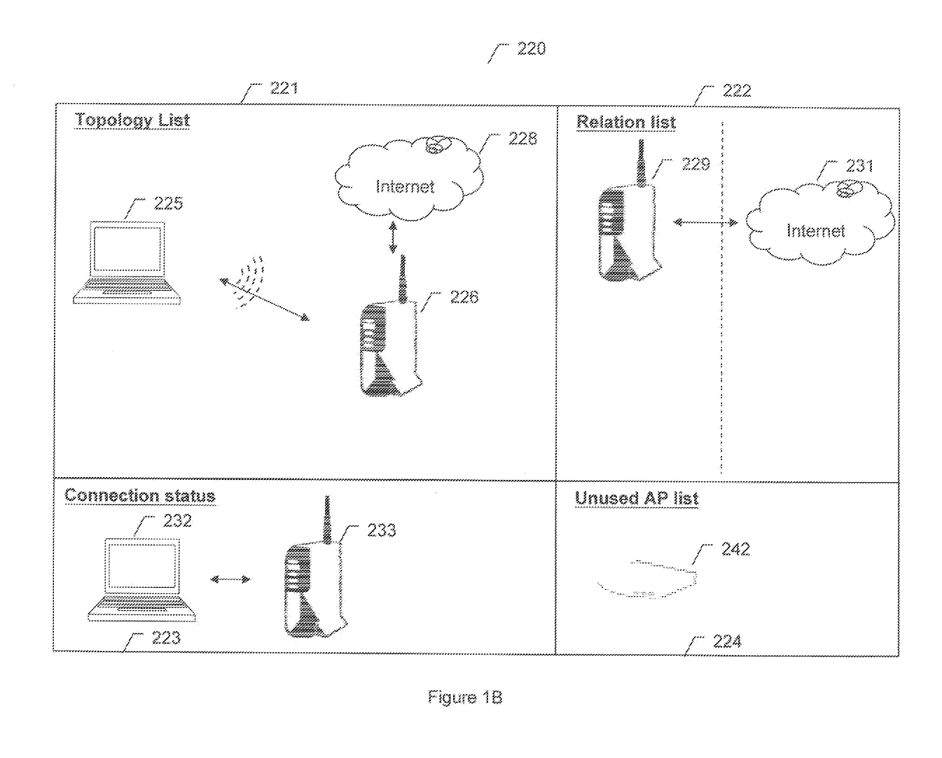

Refer to FIG. 1A, which is a block diagram illustrating a wireless network environment according to an embodiment of the present invention.

Using the method of the present invention a wireless network environment 100 can be much more extensive while still being easy to configure and maintain.

Such an environment 100 as shown in FIG. 1A can comprise a computer 110, an access point 120, an access point client 140, access point enabled devices 150,151,152, and access to the Internet 130. The access point enable devices 150,151,152 can comprise, for example, an AP enabled TV, AP enabled speakers, AP enabled gaming devices, or AP enabled stereo system.

In order to wirelessly connect a computer to an AP the device is set to AP mode upon power up or reset. A user selects to perform a scan by clicking the scan button of the software user interface. The computer will scan for any APs. The computer software will scan using the scan application programming interface (API) provided by the operating system.

The computer software gets the scanning information and displays it in the software user interface. The computer software then connects to the detected AP using the connect API provided by the operating system. After connecting to the AP, the computer gets the AP's information.

After performing the check the software stores all the data in the database and displays appropriate information in the software user interface. The detected APs and connections are displayed in a topological diagram. The user can easily configure or reconfigure the connections by dragging icons of the devices in the software user interface. Any changes to the device hierarchy or device connections are automatically managed by the software. In this way the connections between devices is automatically reconfigured by the software to reflect changes made by the user. The user isn't required to manually reconfigure the network.

Refer to FIG. 1B, which is a diagram illustrating a graphical user interface with topological diagram of network configuration according to an embodiment of the present invention.

It should be noted that the various components displayed in the various sections of the user interface 220 are the same devices but are given different element identifications for clarity. For example, the access point 226 in the topological list 221 is the same access point as access point 229 in the relation list 222 and access point 232 in the connection list.

The user interface 220 of the present invention comprises a topological list 221, a relation list 222, a connection status area 223, and an unused device area 224. The topological list 221 displays the current network configuration in a topological diagram. All devices in the network are represented by a corresponding icon. In the example illustrated in FIG. 1B, the network comprises a computer 225, a wireless access point 226, and connection to the Internet 228. The connections between the network components are clearly illustrated in order to provide the user will a clear impression of the network configuration. For example, the computer 225 is wirelessly connected to the access point 226 which is connected to the Internet 228.

In the relation list 222 the relationship between the components is displayed. The relation list 222 is divided into two sections. One section for access points and another section for access point clients or other components connecting to the access point. In this example, the access point 226 in the topological list is displayed in the left side of the relation list 222 as access point 229. The right side of the relation list 222 shows the access point 229 connected to the Internet 231.

When a user clicks on a device in the topological list 221 or the relation list 222, the appropriate connection configuration for that device is displayed in the connection status area 223. In this example, the user has clicked on the access point 226. The connection status area 223 shows that the access point 233 is connected to the computer 232.

In certain network situations there are unused or extra devices that are not currently connected to the network. These devices are displayed in the unused devices area 224 of the user interface 220. In FIG. 1B, an unused access point 242 is available but not currently utilized. Additionally, if there are more devices available than the network can support, these extra devices are displayed in the unused devices area 224. Devices that are shown in the unused devices area 224 can easily be utilized in the network by dragging the icon for the device into the topological list 221 or the relation list 222. If the configuration is compatible the user interface is updated to display the new configuration. If the configuration is incompatible, a warning message is displayed notifying the user of a configuration problem. Also, if a user wants to disconnect a device from the network, the user can simply drag the icon for the device from the topological list 221 or the relation list 222 into the unused devices area 224.

The user interface 220 of the present invention clearly and logically displays the network configuration including devices and connections between devices. Users can quickly and easily configure or reconfigure their network without a high level of technical experience.

Furthermore, each icon in the user interface has a label identifying the device. The device labels can easily be changed by the user to more clearly identify the device or to allow users to recognize devices. Additionally, users can change the various icons in order to improve clarity or distinction between devices. This also allows users to customize the look of the user interface. In an embodiment of the present invention, a devices icon automatically changes to reflect a change in device status. For example, if an access point is reconfigured as an access point client, the icon is changed from an access point icon to an access point client icon.

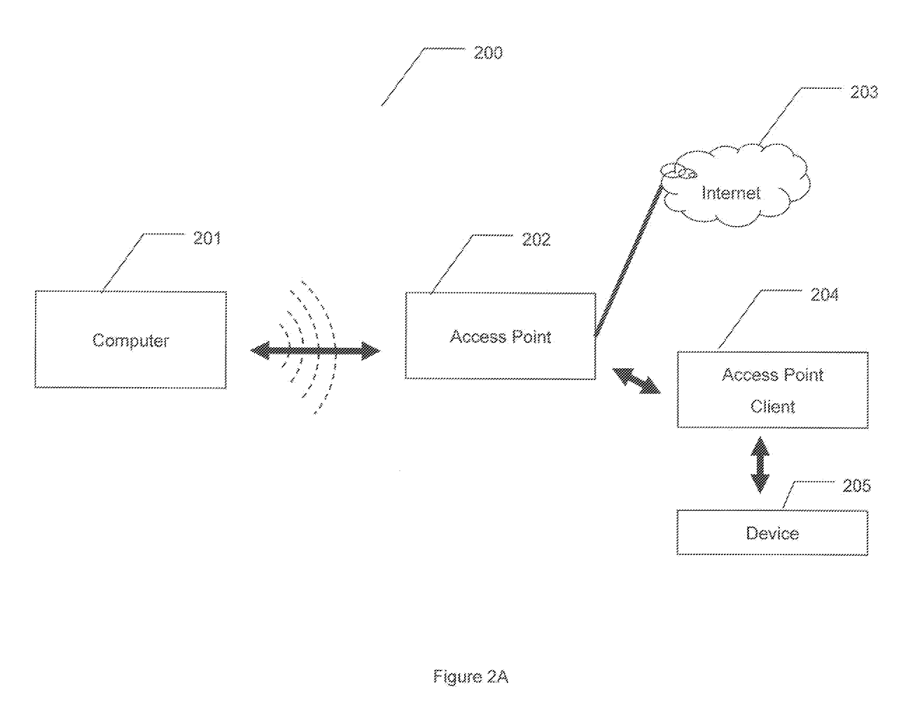

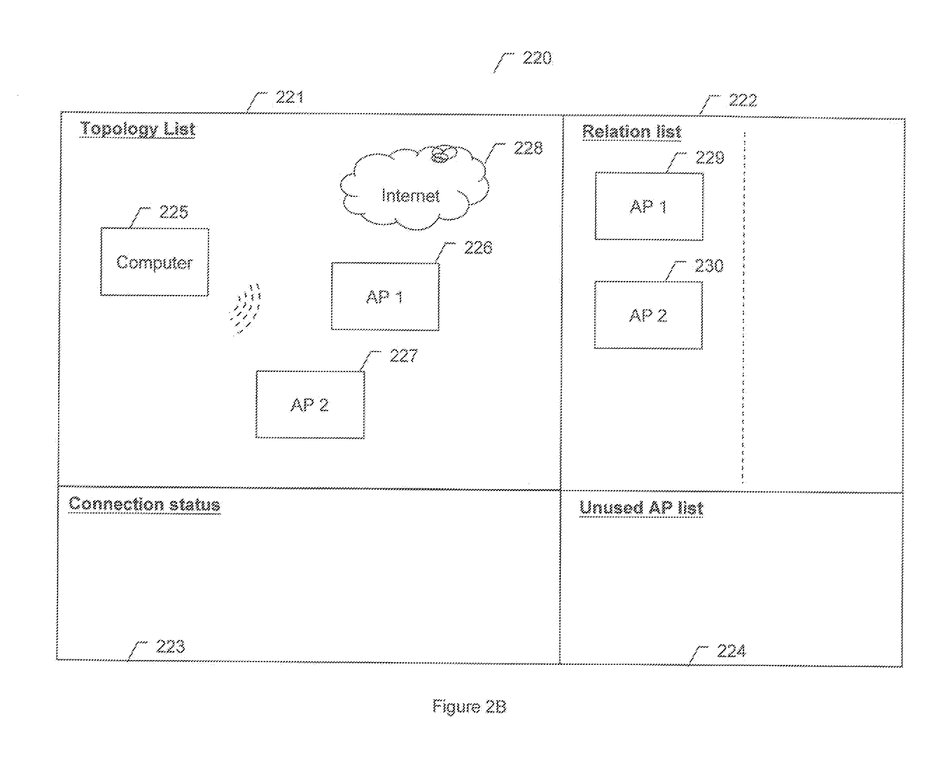

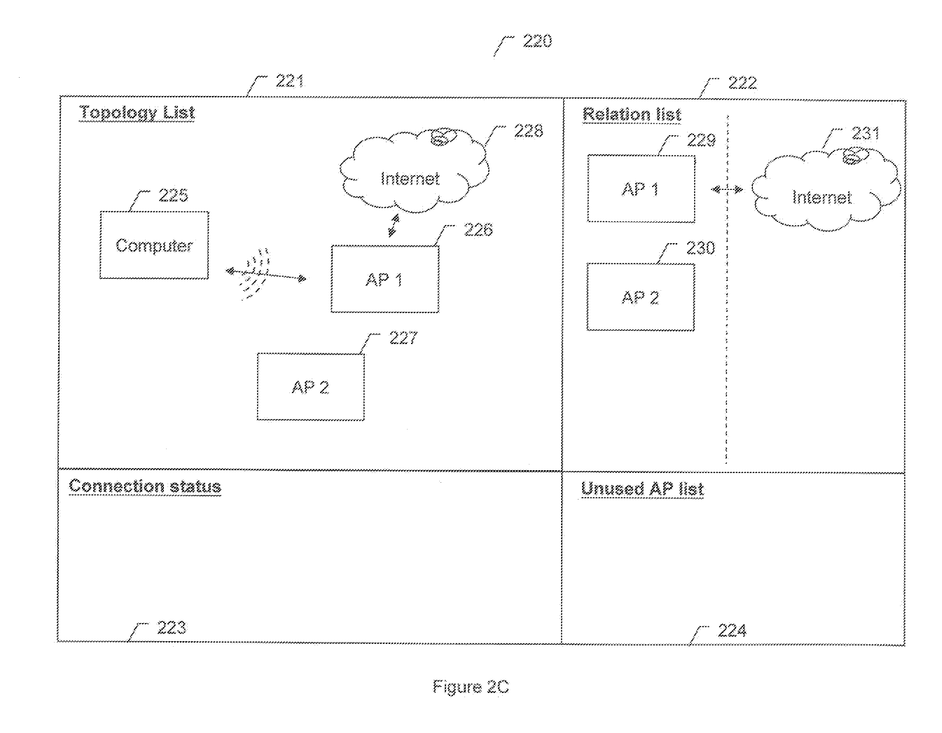

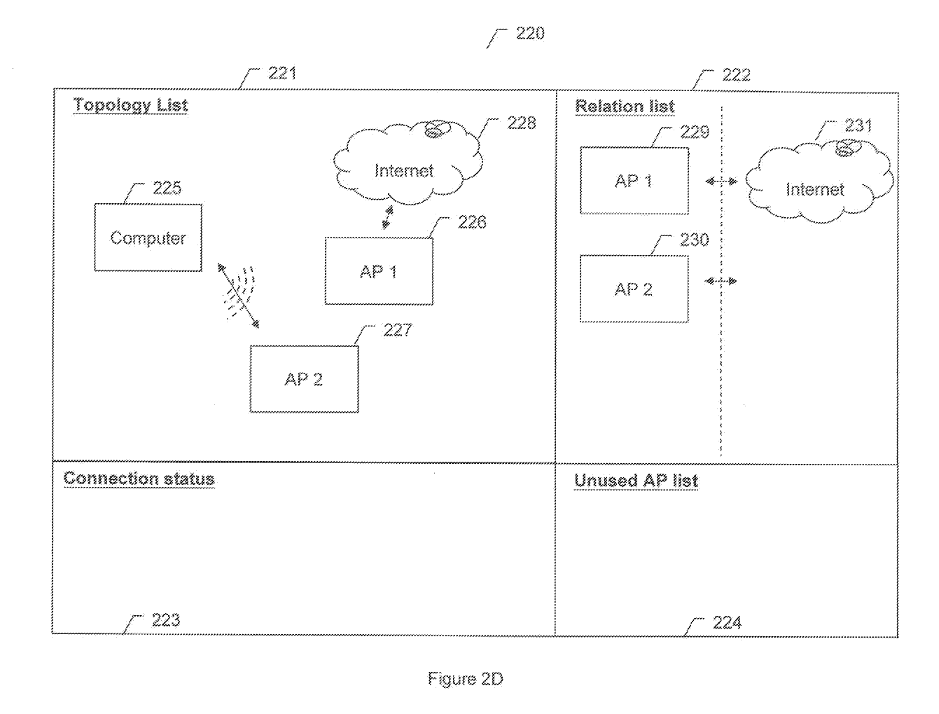

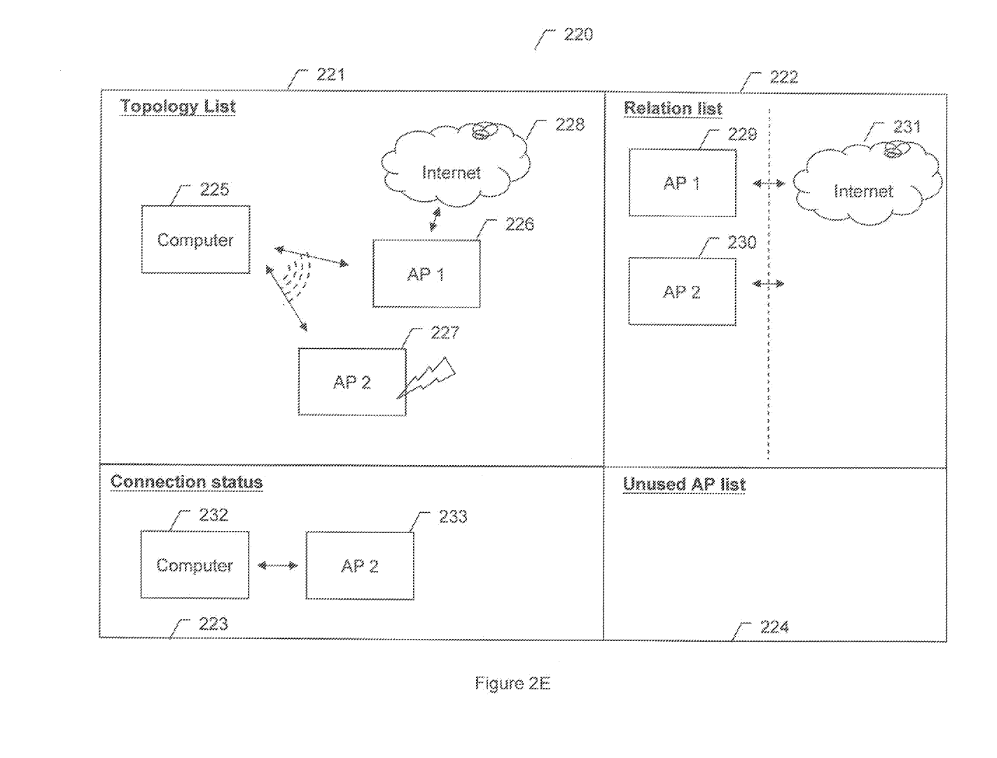

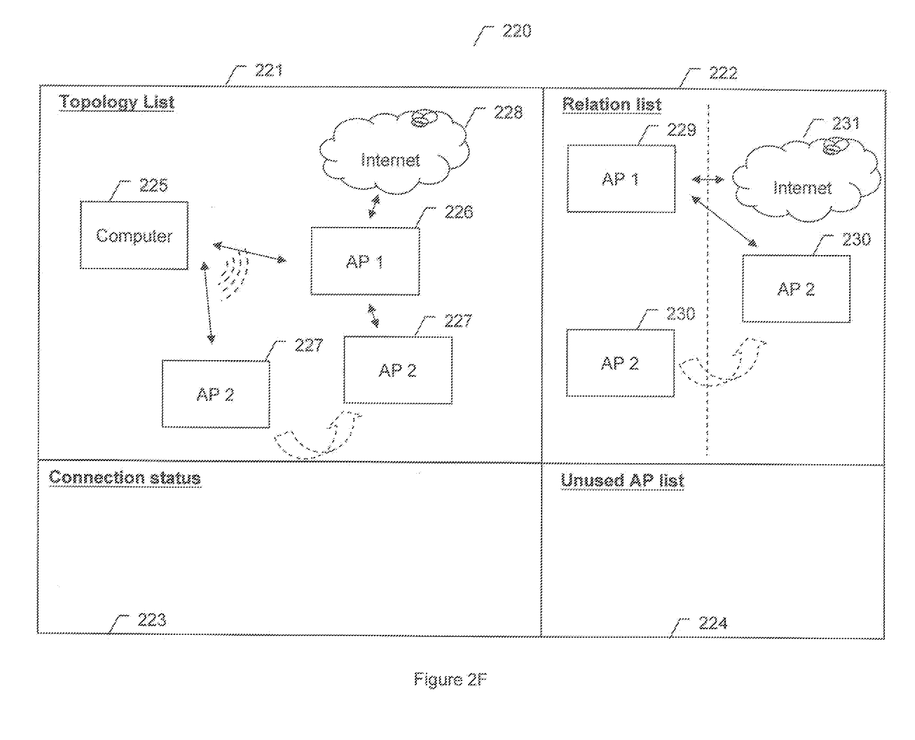

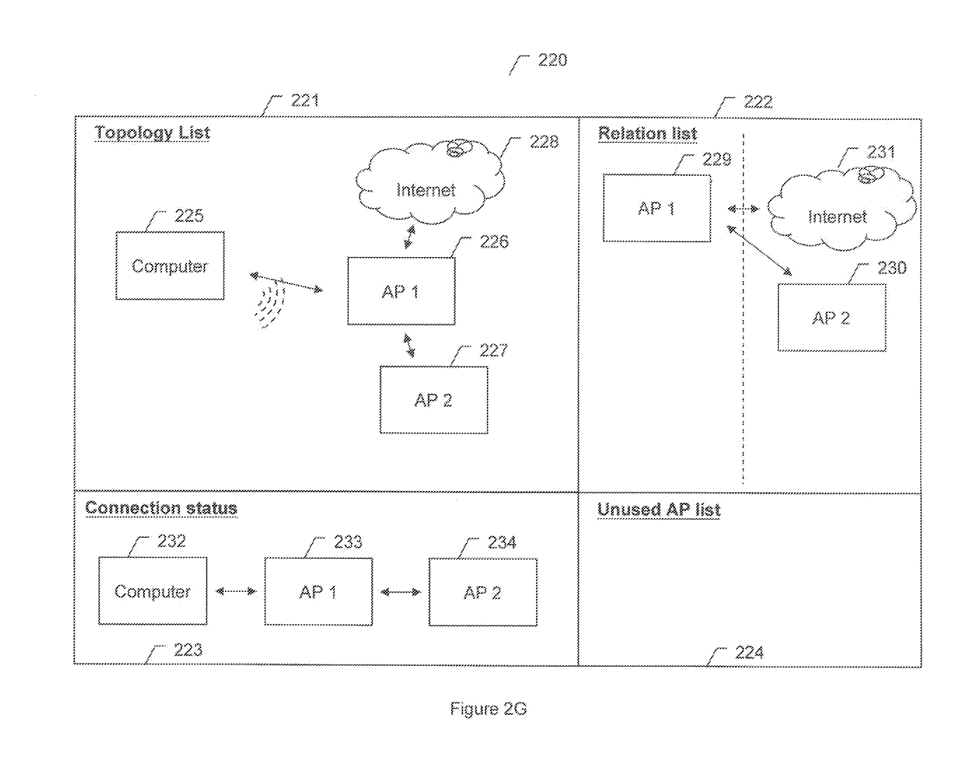

Refer to FIG. 2A, which is a diagram illustrating a basic wireless environment according to an embodiment of the present invention.

The wireless network environment 200 of FIG. 2A comprises a computer 201, a first AP 202, a second AP 204, a wireless device 205, and access to the Internet 203. A user can access internet resources using the first AP 202. The second AP 204 is configured as an AP client and connects the wireless device 205 to the computer 201 via the first AP 202.

The wireless network environment illustrated in FIG. 2A is configured as follows. The AP device is set to AP mode upon power up or reset. A user selects to perform a scan by clicking the scan button of the software user interface. The computer will scan for all APs. The computer software will scan using the scan application programming interface (API) provided by the operating system.

The computer software will find all APs and display them in the topology diagram of the software user interface. The computer software saves all the scanning information in a computer side database.

In this example the computer detects the first AP and the second AP. Initially both the first AP and the second AP are displayed as master APs. The user decides whether connection should be made with the second AP or if the second AP should be configured as an AP client.

If the user decides that the computer is to connect to the second AP, the user simply clicks the second AP icon in the topological diagram of the software user interface. The computer software will then automatically connect the computer to the second AP.

If the user decides that the second AP should be an AP client, the second AP will connect under the first AP. If the user is required to enter a WEP key, a pop-up window will ask the user to enter the key. In a WEP key isn't required this step is skipped. Finally, the computer software will automatically reconfigure the network so that the computer will connect to the second AP or AP client via the first AP.

Refer to FIG. 2B, which is a diagram illustrating a graphical user interface for the computer of the wireless network environment of FIG. 2A according to an embodiment of the present invention.

The software user interface 220 of the present invention comprises a topological list 221, a relation list 222, connection status 223, and an unused AP list 224.

After the computer 225 scans the environment, all detected APs 226,227 are display as icons in the topological list 221. In the example environment of FIG. 2A, the computer 225 detects a first AP 226 and a second AP 227 and the interface 220 displays both of these in the topological list 221.

The first AP 229 and the second AP 230 are displayed as icons in the relation list 222. The relation list comprises an AP section and a section showing devices or networks connected to the AP. Since both the first AP 229 and second AP 230 were detected as APs, they are displayed in the AP section. At this time, the other section is empty.

Refer to FIG. 2C, which is a diagram illustrating a graphical user interface for the computer of the wireless network environment of FIG. 2A according to an embodiment of the present invention.

In this example, the user selects to connect the computer 225 to the Internet 228 via the first AP 226. The user simply clicks on the first AP 226 icon in the topological list 221. The software saves the configuration information in the computer-side database and automatically configures the wireless environment. The topological list 221 of the software user interface 220 displays the connection between the computer 225 and the Internet 228 via the first AP 226.

The relation list 222 shows the first AP 229 in the AP section and the Internet 231 as being connected to the first AP 229 in the other section. At this time the second AP 230 is shown as being disconnected from the computer and Internet 231 in both the topological list 221 and the relation list 222.

Refer to FIG. 2D, which is a diagram illustrating a graphical user interface for the computer of the wireless network environment of FIG. 2A according to an embodiment of the present invention.

If the user decides that the computer 225 should connect to the second AP 227, the user simply clicks on the second AP 227 icon in the topological list 221. The software saves the configuration information in the computer-side database and automatically configures the wireless environment. The topological list 221 of the software user interface 220 displays the connection between the computer 225 and the second AP 227.

The relation list 222 shows the second AP 230 in the AP section and the other section is empty. At this time the first AP 229 is shown as being disconnected from the computer 225 but connected to the Internet 228 in both the topological list 221 and the relation list 222.

Refer to FIG. 2E, which is a diagram illustrating a graphical user interface for the computer of the wireless network environment of FIG. 2A according to an embodiment of the present invention.

Once AP configuration data is stored in the computer-side database, a user can simply click on an AP icon 227 in the topological list 221 and the software will automatically configure the environment.

The connection information is displayed in the connection status section 223 of the software user interface 220. In this example, the connection status section 223 shows the computer 232 connected to the second AP 233.

In an embodiment of the present invention, the second AP comprises an audio device, for example, a soundcard. Once the user clicks on the second AP in the topological list, audio being played by the computer is heard from the audio device. In this way, the present invention allows the computer to wirelessly connect to an audio device and audio normally heard from the computer's speakers can now be heard from the audio device. This allows users to listen to music on their quality home audio system rather than listening to the inferior audio quality from the computer speakers.

Refer to FIG. 2F, which is a diagram illustrating a graphical user interface for the computer of the wireless network environment of FIG. 2A according to an embodiment of the present invention.

If a user decides that the second AP 227 should be an AP client, the user simply drags the icon for the second AP 227 over to the first AP 226. The software reconfigures the second AP 227 as an AP client and saves the configuration information in the computer-side database. The software user interface 220 shows the computer 225 connected to the Internet 231 and second AP 230 via the first AP 229.

In situations where the user tries to configure the environment in a way that is not possible or where devices are incompatible, the software will notify the user that the connection or configuration is not possible. This prevents the user from inadvertently mis-configuring the environment.

Refer to FIG. 2G, which is a diagram illustrating a graphical user interface for the computer of the wireless network environment of FIG. 2A according to an embodiment of the present invention.

When the user wants the computer 225 to connect to the second AP 227, the user clicks on the icon for the second AP 227 and the computer 225 communicates with the second AP 227 via the first AP 226. The connection information is displayed in the connection status section 223.

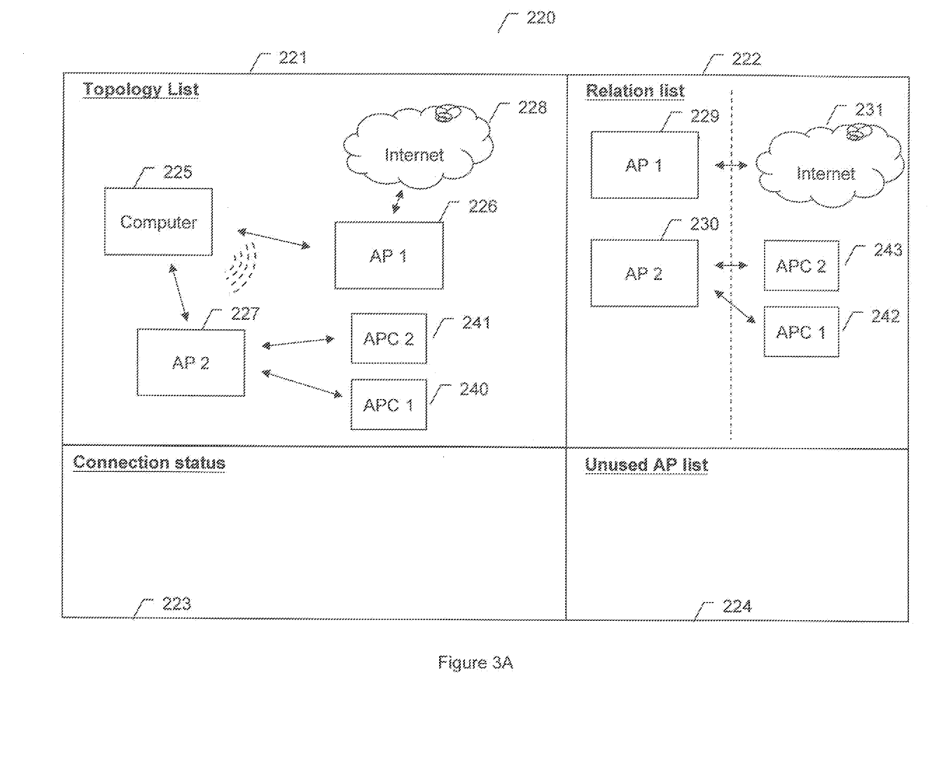

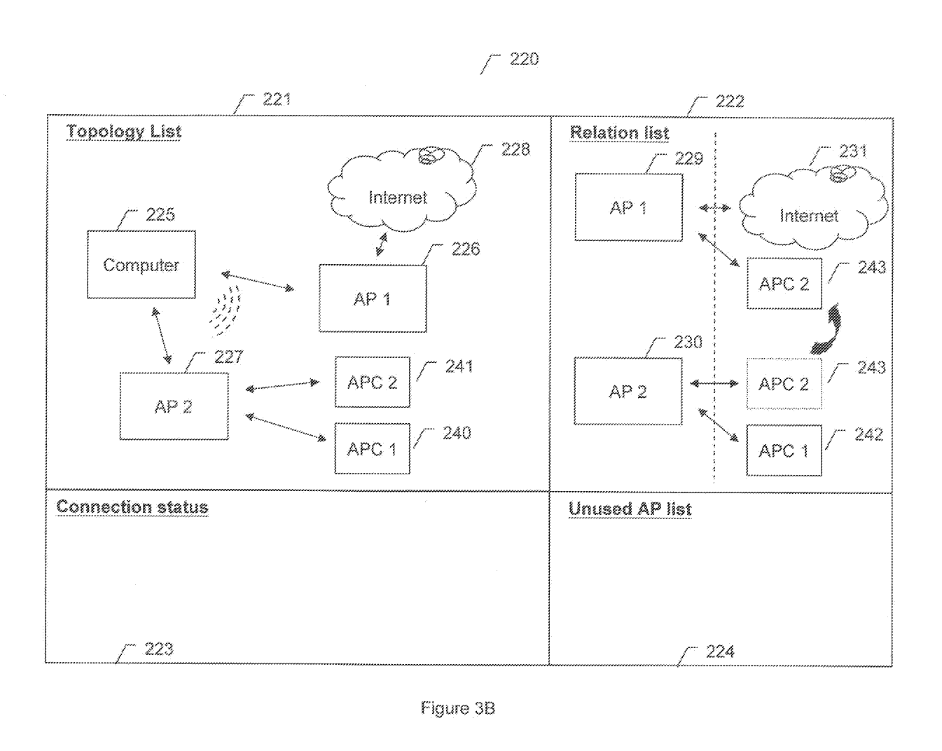

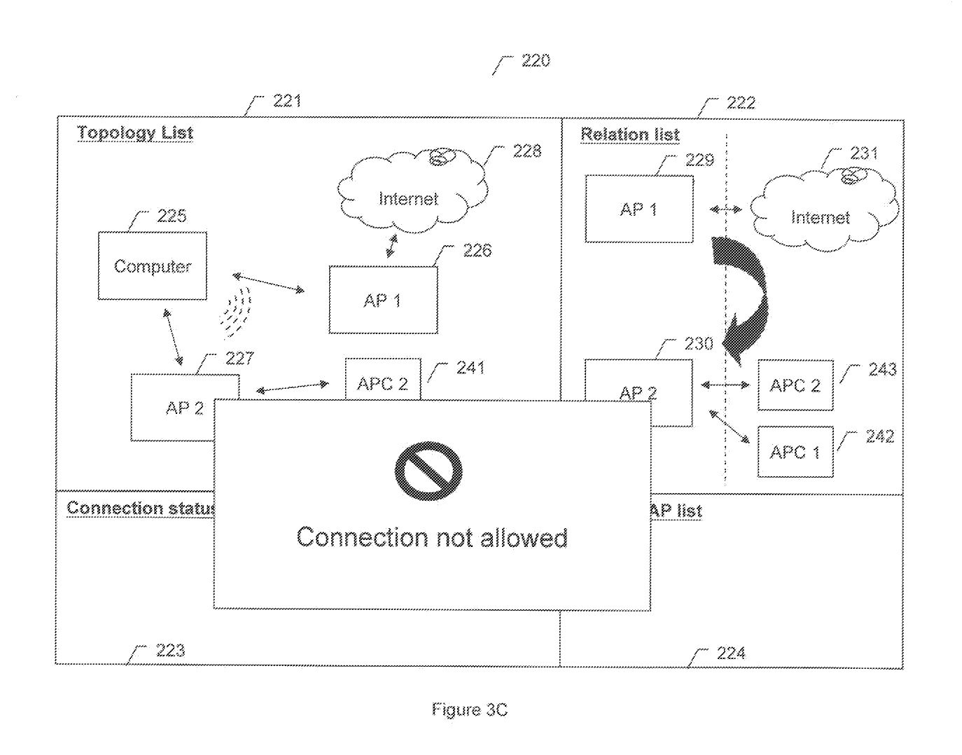

Refer to FIG. 3A, which is a diagram illustrating a graphical user interface for a computer of a wireless network environment according to an embodiment of the present invention.

The wireless network environment illustrated in FIG. 3A comprises a computer 225 connected to a first AP 226 and a second AP 227. The first AP 226 is configured to allow the computer 225 to access the Internet 228. A first AP client 240 and a second AP client 241 are connected to the second AP 227. The software user interface 220 displays the connection data in the topological list 221 and relation list 222.

Refer to FIG. 3B, which is a diagram illustrating a graphical user interface for a computer of a wireless network environment according to an embodiment of the present invention, and to FIG. 3C, which is a diagram illustrating a graphical user interface warning message.

To reconfigure the network environment, the computer scans and saves all connection information in the computer-side database. The user drags an AP client 243 over to the first AP 229 in order to reconfigure network so that the AP client 243 is under the first AP 229. Next, the software determines whether the first AP 229 is a routing AP.

If the first AP 229 is a routing AP the software will connect to the AP client 243 and change its configuration to link to the first AP 229. If the AP requires a WEP key, the user is prompted to enter the key.

After the configuration is saved, the user will see the new configuration information in the software user interface 220 as shown in FIG. 6C.

In some cases a user may try to reconfigure the network in a manner that is invalid. For example, if a user dragged AP 1 229 to be under AP 2 230 which isn't allowed. The software will notify the user that the connection or configuration is not possible as shown in FIG. 3C. This prevents the user from inadvertently mis-configuring the environment.

When the user reconfigures the network environment the software automatically prompts the user with a message asking if the original connection and configuration information should be saved. In the above example, the first AP client was moved to be under the first AP. The original configuration comprised a first AP client and second AP client under a second AP. The software asks the users if the connection information for the first AP client and second AP client should be saved. If the user opts to save the information it is saved in the computer-side database. In this way, if the user reconfigures the environment back to the original state, the software retrieves the information from the database and automatically configures the environment.

If an AP client needs to be changed to AP mode, the software prompts the user as to whether the software should automatically reconfigure the AP client or not. If the user chooses not to reconfigure the AP client, the user can hard-reset the AP client and the AP will automatically restart in AP mode.

If the user wants to connect to an AP client and the computer cannot detect the master AP, the software will automatically scan for the master AP. If the software detects the master AP the connection information is stored in the connection database. If the computer still cannot detect the master AP, the software will prompt the user asking whether or not to keep the connection information. If the user wants to keep the information it is stored in the database. If the user doesn't want to keep the information it is discarded and the user is prompted to reset the AP client.

During the time that the computer cannot detect the master AP, the software user interface will show that there is a problem in connection status. This is illustrated in the topological list, the relation list, and the connection status section.

Similarly, if the user wants to connect to an AP client and the computer cannot detect the AP client, the software will automatically scan for the AP client. If the software detects the AP client the connection information is stored in the connection database. If the computer still cannot detect the AP client, the software will prompt the user asking whether or not to keep the AP client connection information. If the user wants to keep the information it is stored in the database. If the user doesn't want to keep the information it is discarded.

The graphical user interface shows the current connection and configuration status. When the computer can't detect an AP client, the situation will be displayed in the user interface.

When a user tries to add another AP or device that exceeds the maximum allowable devices or connections, the software will prompt the user to first remove the AP or device. The user can easily remove a device by clicking and dragging the icon for the device and placing the icon in the unused AP list. The icon for the device will be displayed in the unused AP list for future use. When the user wants to use the device, the user simply drags the device back into the relation list or the topological list.

After removing the device, the user is able to add the new device. The computer will connect to the device and configuration is achieved as described above. The connection information is saved in the computer-side database and the user interface shows the current connection status.

When a computer cannot detect a particular AP or AP client and the computer has an Ethernet connection, the computer scans to detect the AP or AP client via the Ethernet. If the computer detects the device, the computer will reconfigure the device as an Ethernet device. The device will now be displayed in the user interface as an Ethernet device in the unused AP list.

Similarly, if the computer is wirelessly connected to an AP with an Ethernet connection, the computer scans the Ethernet via the AP. If the computer detects the device, the computer will reconfigure the device as an Ethernet device.

As described above, the method of the present invention provides easy connection and configuration of electronic devices in a wireless network environment by displaying the topology of the network in a graphical user interface. Additionally, electronic devices do not need to be physically connected to access points via a cable in order to configure the connection.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A graphical user interface for configuring a network comprising:
a topological list for displaying network topology;
a relation list for displaying relationship between connected devices;
a connection status area for displaying connection status of connected devices; and
an unused devices area for displaying devices that are not connected to the network.

2. The graphical user interface for configuring a network of claim 1, further comprising:
a warning message for notifying a user of an incompatible configuration.

3. A method for configuring a network utilizing a graphical user interface comprising:
displaying a topological list showing network topology, the topological list displaying an icon representing a device in the network and allowing a user to drag the icon to a new location in the network in order to reconfigure the network.

4. The method for configuring a network utilizing a graphical user interface of claim 3, further comprising:
displaying a relation list showing relationship between connected devices;
displaying a connection status area showing connection status of connected devices; and
displaying an unused devices area showing devices that are not connected to the network.

5. The method for configuring a network utilizing a graphical user interface of claim 3, further comprising:
displaying a warning message if a network configuration is incompatible.

6. The method for configuring a network utilizing a graphical user interface of claim 3, further comprising:
automatically reconfiguring the network when a device's connection has changed.

7. The method for configuring a network utilizing a graphical user interface of claim 3, further comprising:
automatically updating the graphical user interface to display new network configuration.

8. The method for configuring a network utilizing a graphical user interface of claim 7, the updating comprising:
updating the topological list.

9. The method for configuring a network utilizing a graphical user interface of claim 8, the updating further comprising:
updating the relation list, the connection status area, and the unused devices area.

10. The method for configuring a network utilizing a graphical user interface of claim 4, the graphical user interface displaying an icon representing each device and each device's connection relationship in the network in the relation area.

11. The method for configuring a network utilizing a graphical user interface of claim 10, the graphical user interface allowing a user to drag the icon to a new location in the relation list in order to reconfigure the network.

12. A method for configuring a network utilizing a graphical user interface comprising:
displaying a topological list showing network topology;
displaying a relation list showing relationship between connected devices;
displaying a connection status area showing connection status of connected devices; and
displaying an unused devices area showing devices that are not connected to the network.

13. The method for configuring a network utilizing a graphical user interface of claim 12, further comprising:
displaying a warning message if a network configuration is not compatible.

14. The method for configuring a network utilizing a graphical user interface of claim 12, further comprising:
automatically reconfiguring the network when a device's connection has changed.

15. The method for configuring a network utilizing a graphical user interface of claim 12, further comprising:
automatically updating the graphical user interface to display new network configuration.

16. The method for configuring a network utilizing a graphical user interface of claim 15, the updating comprising:
updating the topological list and the relation list.

17. The method for configuring a network utilizing a graphical user interface of claim 16, the updating further comprising:
updating the connection status area and the unused devices area.

18. The method for configuring a network utilizing a graphical user interface of claim 12, the graphical user interface displaying an icon representing each device in the network.

19. The method for configuring a network utilizing a graphical user interface of claim 12, the graphical user interface allowing a user to drag a device to a new location in the topological list in order to reconfigure the network.

20. The method for configuring a network utilizing a graphical user interface of claim 12, the graphical user interface allowing a user to drag a device to a new location in the relation list in order to reconfigure the network.
